(19) United States
(12) Patent Application Publication
(10) Pub. No.: US 2024/0314824 A1
(43) Pub. Date: Sep. 19, 2024

(54) Selective BWP Interruptions for L1 Measurements

(71) Applicant: MediaTek Singapore Pte. Ltd., Singapore (SG)

(72) Inventors: Waseem Hazim Ozan Ozan, Cambridge (GB); Tsang-Wei Yu, Hsinchu City (TW)

(21) Appl. No.: 18/432,144

(22) Filed: Feb. 5, 2024

Related U.S. Application Data
(60) Provisional application No. 63/489,792, filed on Mar. 13, 2023.

(51) Int. Cl. H04W 72/51; H04W 16/28; H04W 72/0457; H04W 72/231

(52) U.S. Cl. CPC H04W 72/51; H04W 16/28; H04W 72/0457; H04W 72/231

(57) ABSTRACT

Techniques pertaining to the selective use of BWP interruptions for performing L1 measurements are described. A user equipment (UE) determines whether a resource for use to perform a Layer 1 (L1) measurement for a serving cell of a wireless communication network is within a corresponding active bandwidth part (BWP) of the resource. In response to determining that the resource is outside the corresponding active BWP of the resource, the UE reports to the wireless communication network that the UE needs an interruption to the corresponding active BWP of the resource.

### CROSS REFERENCE TO RELATED PATENT APPLICATION(S)

The present disclosure is part of a non-provisional application claiming the priority benefit of U.S. Patent Application No. 63/489,792, filed 13 Mar. 2023, the content of which herein being incorporated by reference in its entirety.

### TECHNICAL FIELD

The present disclosure is generally related to mobile communications and, more particularly, to the performance of Layer 1 (L1) measurements for a serving cell.

### BACKGROUND

Unless otherwise indicated herein, approaches described in this section are not prior art to the claims listed below and are not admitted as prior art by inclusion in this section.

In existing 5G implementations, synchronization signal blocks (SSBs) may be used for RLM measurements, BFD measurements, etc. Thus, a UE may be configured by a 5G-based wireless communication network to use an SSB to perform a Layer 1 (L1) measurement for a serving cell when the SSB is within its active bandwidth part (BWP). Layer 1 may refer to a physical layer as specified in the 3GPP specifications. However, the current 3GPP specifications do not define UE behavior for performing SSB-based L1 measurements when an SSB is outside of its active BWP. In some instances, when an SSB is outside of its active BWP, a UE may be configured to implement a radio frequency (RF) bandwidth (BW) that is sufficient to cover both the BWP and the corresponding SSB without the need for RF re-tuning. However, such implementation may result in higher power consumption for the UE. Alternatively, the wireless communication network may configure the UE with a measurement gap so that the UE may measure the SSB outside of its active BWP. However, such an alternative solution may affect data transmission and reception by the UE, thereby resulting in lower data throughput. Therefore, there is a need for a solution that enables a UE to perform L1 measurements of a serving cell using a resource (e.g., an SSB) regardless of whether the resource is within its active BWP.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions that enable a UE to perform L1 measurements for a serving cell using a resource (e.g., an SSB) regardless of whether the resource is within its active BWP. Thus, it is believed that implementations of various proposed schemes in accordance with the present disclosure may address or otherwise alleviate issues described herein.

In one aspect, an apparatus may include a transceiver configured to communicate wirelessly and a processor coupled to the transceiver. The apparatus may use a resource to perform at least one L1 measurement for a serving cell of the wireless communication network. The processor of the apparatus may determine whether the resource is within a corresponding active BWP of the resource. The processor may also, in response to determining that the SSB is outside the corresponding active BWP of the resource, report to the wireless communication network that the apparatus needs an interruption to the corresponding active BWP of the resource.

In another aspect, an apparatus may include a transceiver configured to communicate wirelessly and a processor coupled to the transceiver. The apparatus may use a resource to perform at least one L1 measurement for a serving cell of the wireless communication network. The processor of the apparatus may determine whether the resource is within a corresponding active BWP of the resource. The processor may also, in response to determining that the SSB is outside the corresponding active BWP of the resource, perform one or more of reporting to the wireless communication network that the apparatus does not need an interruption to the corresponding active BWP of the resource or performing the at least one L1 measurement without interrupting the corresponding active BWP.

In yet another aspect, a method may include receiving, at a wireless communication network, a bandwidth capability of a UE from the UE, in which the UE uses a resource to perform at least one L1 measurement for a serving cell of a wireless communication network. The method also includes configuring, at the wireless communication network, whether the UE is to use an interruption when the resource is outside a corresponding active BWP of the resource, the configuring being performed at least based on the bandwidth capability of the UE. The method further includes sending a configuration on the use of the interruption by the UE from the wireless communication network to the UE for implementation by the UE.

It is noteworthy that, although the description provided herein may be in the context of certain radio access technologies, networks, and network topologies such as 5G/NR mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example implementation in accordance with the present disclosure.

FIG. 3 is a block diagram of an example communication system in accordance with an implementation of the present disclosure.

FIG. 4 is a flowchart of a first example process in accordance with an implementation of the present disclosure.

FIG. 5 is a flowchart of a second example process in accordance with an implementation of the present disclosure.

FIG. 6 is a flowchart of a third example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes, and/or solutions that enable a UE to perform L1 measurements for a serving cell using a resource regardless of whether the resource is within its active BWP. According to the present disclosure, a number of possible solutions may be implemented separately or jointly. That is, although these possible solutions may be described below separately, two or more of these possible solutions may be implemented in one combination or another.

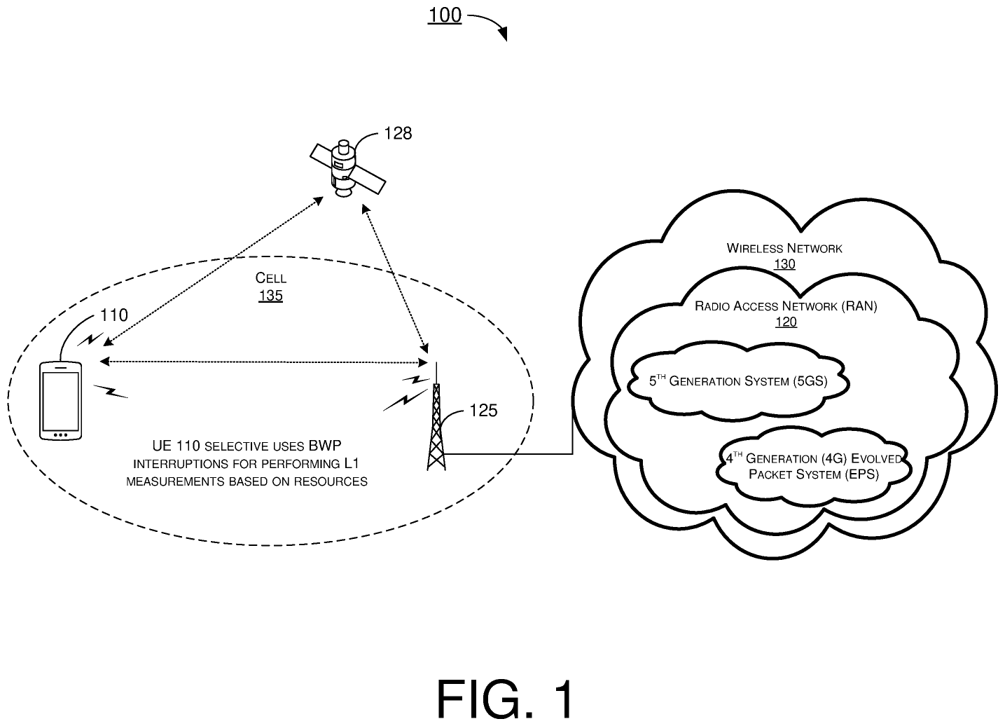

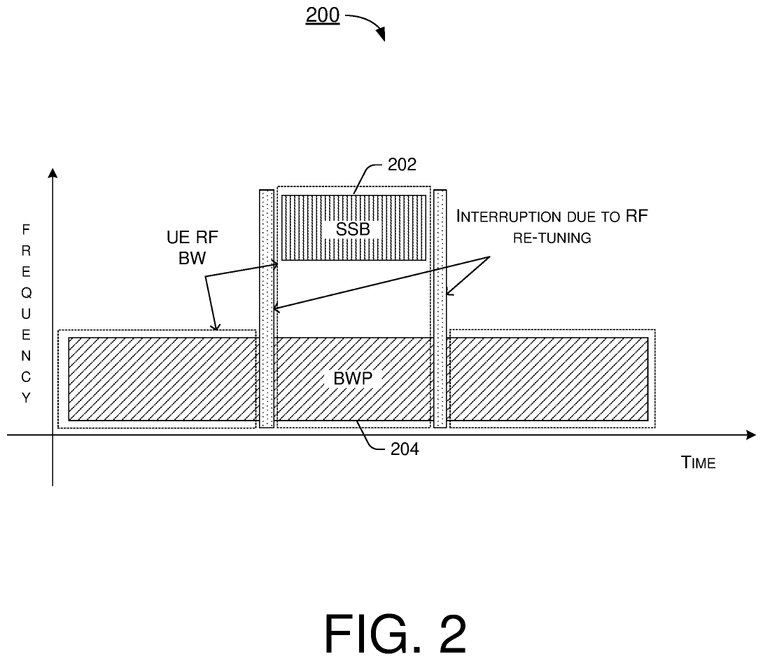

FIG. 1 illustrates an example network environment 100 in which various solutions and schemes in accordance with the present disclosure may be implemented. FIG. 2-FIG. 6 illustrate examples of implementation of various proposed schemes in network environment 100 in accordance with the present disclosure. The following description of various proposed schemes is provided with reference to FIG. 1-FIG. 6.

Referring to FIG. 1, network environment 100 may involve a UE 110 in wireless communication with a radio access network (RAN) 120 (e.g., a 5G NR mobile network or another type of network such as an NTN). UE 110 may be in wireless communication with RAN 120 via a base station or terrestrial network node 125 (e.g., an eNB, gNB or transmit-receive point (TRP)) and/or via a satellite or non-terrestrial network node 128. That is, UE 110 may be within coverage of a cell 135 associated with terrestrial network node 125 or non-terrestrial network node 128. RAN 120 may be a part of a network 130. In network environment 100, UE 110 and network 130 (via terrestrial network node 125 or non-terrestrial network node 128 of RAN 120) may implement various schemes that enable a UE to perform L1 measurements for a serving cell (e.g., network node 125) using a resource (e.g., an SSB) regardless of whether the resource is within its active BWP, as described below. The serving network cell may be a PCell, a SCell, or a PSCell. It is noteworthy that, although various proposed schemes, options, and approaches may be described individually below, in actual applications these proposed schemes, options, and approaches may be implemented separately or jointly. That is, in some cases, each of one or more of the proposed schemes, options, and approaches may be implemented individually or separately. In other cases, some or all of the proposed schemes, options, and approaches may be implemented jointly.

According to a proposed scheme of the present disclosure, the UE 110 may be configured by the network 130 to selectively use interruptions when using resources, such as SSBs, to perform L1 measurements for a serving cell, as well as report to the network 130 whether the UE 110 needs interruptions to perform the L1 measurements. The UE 110 may receive the resources from the serving cell in downlink transmissions from the serving cell. Such selective use of interruptions may enable the UE 110 to use a resource to perform an L1 measurement for the serving cell regardless of whether the resource is within or outside of its active BWP.

Accordingly, when the UE 110 is configured to use a resource to perform one or more Layer 1 (L1) measurements for a serving cell of a wireless communication network, the UE 110 may determine whether the resource is within a corresponding active BWP of the resource. For example, the L1 measurements may include L1-reference signal received power (L1-RSRP) measurements, L1-signal to interference plus noise ratio (L1-SINR) measurements, L1-reference signal received quality (LI-RSRQ) measurements, radio link monitoring (RLM) measurements, beam failure detection (BFD) measurements, candidate beam detection (CBD) measurements, etc. Thus, when the resource (e.g., the SSB) is within a corresponding active BWP of the resource, the UE 110 may determine that it does not need to interrupt the corresponding active BWP to perform the one or more L1 measurements for the serving cell. As a result, the UE 110 may report to the network 130 that the UE 110 does not need an interruption to the corresponding active BWP.

However, when the resource (e.g., the SSB) is outside a corresponding active BWP of the resource, the UE 110 may in some instances determine that it does not need to interrupt the corresponding active BWP to perform the one or more L1 measurements for the serving cell. As a result, the UE 110 may report to the network 130 that the UE 110 does not need an interruption to the corresponding active BWP. Alternatively, or concurrently, the UE 110 may perform the one or more L1 measurements for the serving cell without interrupting the corresponding active BWP.

However, in other instances in which the SSB is outside a corresponding active BWP of the SSB, the UE 110 may determine that it does need to interrupt the corresponding active BWP to perform the one or more L1 measurements for the serving cell. For example, as shown in FIG. 2, in order to perform an L1 measurement using the SSB 202, the UE 110 may need to interrupt the corresponding active BWP 204 so that radio frequency (RF) retuning may be conducted before and after performing the L1 measurement based on the SSB 202. In this way, the UE 110 may use the interruption to enlarge and/or shrink one or more of the RF and baseband bandwidth of the corresponding active BWP 204 to perform the L1 measurement. As a result, the UE 110 may report to the network 130 that the UE 110 needs an interruption to the corresponding active BWP.

In these instances, whether the UE 110 needs or does not need an interruption when the resource is outside a corresponding active BWP of the SSB may be dependent on a bandwidth capability of the UE 110. For example, some UEs are capable of maintaining a larger amount of bandwidth capability for uplink and downlink transmission, while other UEs may need to constantly adjust (e.g., enlarge or shrink) their bandwidth capability due to limited computing and/or data communication resources. Furthermore, the network bandwidth capability of the network 130 may also play a role in determining whether the UE 110 needs or does not need an interruption when the resource is outside a corresponding active BWP of the resource. For example, the network bandwidth capability (e.g., available spectrum frequency bands, data throughput rate, amount of network traffic, etc.) of the serving cell in the network 130 may affect an amount of bandwidth capability that the network 130 may be able to provide to the UE 110 at any given time. Thus, the network 130 may configure whether the UE 110 is to use an interruption when the resource is outside a BWP of the resource by taking into consideration the bandwidth capability of the UE 110, or alternatively, taking into consideration the bandwidth capability of the of the UE 110 in combination with the network bandwidth capability of the network 130. Upon determining that the UE 110 is to use the interruption or not use the interruption, the network 130 may send a configuration on the interruption usage to the UE 110 via a network node (e.g. network node 125) of the network. In some implementations, an interruption may include a predetermined time period during which the UE 110 does not perform data transmission or data reception before and after an SSB-based measurement timing configuration (SMTC) window.

Thus, if the UE 110 is configured by the network 130 to use an interruption for performing an L1 measurement when a resource is outside of its corresponding active BWP, the UE 110 may report that there is a need for an interruption to the network 130 each time the UE 110 performs such an L1 measurement using the resource that is outside of its corresponding active BWP. On the other hand, if the UE 110 is configured by the network 130 to not use an interruption for performing an L1 measurement when a resource is outside of its corresponding active BWP, the UE 110 may report that the UE 110 does not an interruption to the network 130 each time the UE 110 performs such an L1 measurement using the resource that is outside of its corresponding active BWP. Once the UE 110 has performed such reporting to the network 130, the UE 110 may proceed with the performance of the L1 measurement.

In various implementations, the UE 110 may perform the reporting after transmission of at least one of a radio resource control (RCC) reconfiguration message, a downlink control information (DCI) message, or a media access control-control element (MAC-CE) message by the wireless communication network. Furthermore, the UE 110 may be configured to perform the reporting via an existing reporting capability of Layer 3 that is used for reporting L1 measurements.

In some instances, the UE 110 may perform an L1 measurement according to an interruption ratio of the interruption to the corresponding active BWP. For example, the interruption ratio may be a ratio of the interruption length (e.g., a time duration of the interruption to the BWP) to a measurement cycle length (e.g., a time duration of the BWP or a portion of the BWP). Thus, the UE 110 may calculate a value for the interruption ratio based on the interruption length and the measurement cycle length, in which the value of the interruption ratio is then used as a part of the calculation of the L1 measurement. In other instances, the UE 110 may perform an L1 measurement according to the interruption length of the interruption to the corresponding active BWP, such that a value of the interruption length is used as a part of the calculation of the L1 measurement. The value of the interruption length may be a predetermined value stored in the UE 110 or a value that is calculated by the UE 110 based on other data transmission parameters (e.g., a value of the SMTC window). In still other instances, the UE 110 may perform an L1 measurement according to an interruption location in the corresponding active BWP, such that a value of the interruption location is used as a part of the calculation of the L1 measurement. Furthermore, data transmission and data reception by the UE 110 may be interrupted based on the interruption length and a measurement cycle length with respect to the corresponding active BWP. For example, the UE 110 may interrupt data transmission and reception for up to 1.25% or 2.25% probability of interruption per a UE measurement sample cycle, in which the SMTC window configuration is not less than 160 ms or 80 ms, respectively.

In some implementations, the configuration that is sent by the network 130 to the UE 110 may not only configure the UE 110 to use interruptions but may also contain specific interruption ratio and/or interruption length values for use by the UE 110 in performing the L1 measurements. However, in alternative implementations, the interruption ratio and/or interruption length values that are used by the UE 110 may be pre-specified values that are stored for use in the memory of the UE 110.

In some implementations, the UE 110 may use an interruption to a corresponding active BWP to conduct an RF re-tuning before and after a performance of the L1 measurement. The RF re-tuning may enlarge a bandwidth of the corresponding active BWP for the purpose of performing an L1 measurement. The RF re-tuning then shrinks the bandwidth of the corresponding active BWP after the L1 measurement is performed. For example, such RF re-tuning may be performed for a L1-RSRP measurement, a L1-SINR measurement, or a L1-RSRQ measurement. In other implementations, the UE 110 may use an interruption to a corresponding active BWP to perform an L1 measurement in the form of a RLM measurement, a BFD measurement, or a CBD measurement.

### Illustrative Implementation

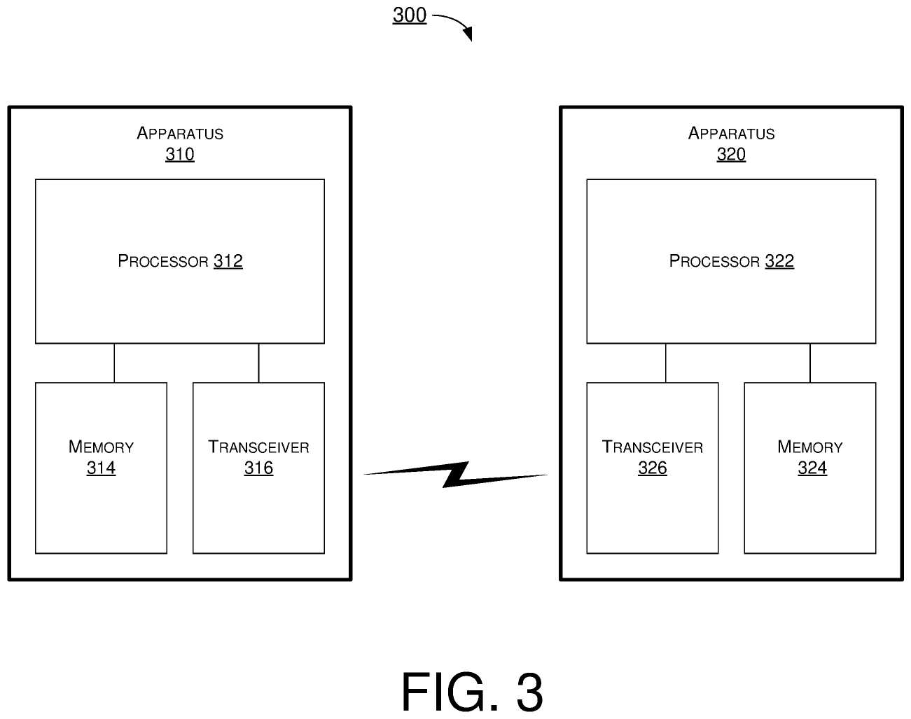

FIG. 3 illustrates an example communication system 300 having at least an example apparatus 310 and an example apparatus 320 in accordance with an implementation of the present disclosure. Each of apparatus 310 and apparatus 320 may perform various functions to implement schemes, techniques, processes, and methods described herein pertaining to the selective use of BWP interruptions for performing L1 measurements, including the various schemes described above with respect to various proposed designs, concepts, schemes, systems and methods described above, including network environment 100, as well as processes described below.

Each of apparatus 310 and apparatus 320 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 310 and apparatus 320 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 310 and apparatus 320 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 310 and apparatus 320 may be implemented in a smart thermostat, a smart fridge, a smart door lock, a wireless speaker, or a home control center. When implemented in or as a network apparatus, apparatus 310 and/or apparatus 320 may be implemented in an eNodeB in an LTE, LTE-Advanced or LTE-Advanced Pro network or in a gNB or TRP in a 5G network, an NR network or an IoT network.

In some implementations, each of apparatus 310 and apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 310 and apparatus 320 may be implemented in or as a network apparatus or a UE. Each of apparatus 310 and apparatus 320 may include at least some of those components shown in FIG. 3 such as a processor 312 and a processor 322, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including those pertaining to the selective use of BWP interruptions for performing L1 measurements in accordance with various implementations of the present disclosure.

In some implementations, apparatus 310 may also include a transceiver 316 coupled to processor 312. Transceiver 316 may be capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of apparatus 310 and apparatus 320 may be a communication entity capable of communicating with each other using various proposed schemes in accordance with the present disclosure. For illustrative purposes and without limitation, a description of capabilities of apparatus 310, as a UE (e.g., UE 110), and apparatus 320, as a network node (e.g., terrestrial network node 125 or non-terrestrial network node 128) of a network (e.g., network 130 as a 5G/NR mobile network), is provided below in the context of example processes 400-600.

### Illustrative Processes

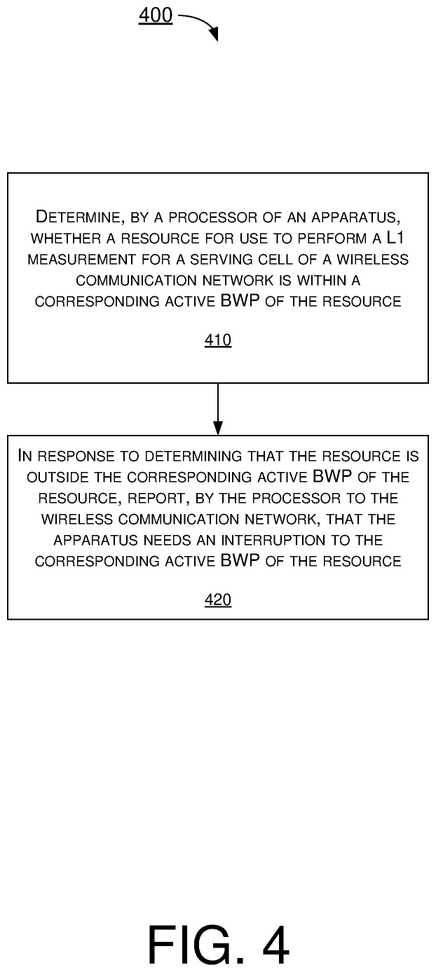

FIG. 4 illustrates an example process 400 in accordance with an implementation of the present disclosure. Process 400 may represent an aspect of implementing various proposed designs, concepts, schemes, systems and methods described above, whether partially or entirely, including those pertaining to those described above. More specifically, process 400 may represent an aspect of the proposed concepts and schemes pertaining to the selective use of BWP interruptions for performing L1 measurements. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 310 and apparatus 320 as well as any variations thereof. Solely for illustrative purposes and without limiting the scope, process 400 is described below in the context of apparatus 310 as a UE (e.g., UE 110) and apparatus 320 as a communication entity such as a network node or base station (e.g., terrestrial network node 125 or non-terrestrial network node 128) of a network (e.g., network 130 as a 5G/NR mobile network). Process 400 may begin at block 410.

At 410, process 400 may include processor 312 of apparatus 310 determining whether a resource for use to perform L1 measurement for a serving cell of a wireless communication network is within a corresponding active BWP of the resource. Process 400 may proceed from 410 to 420.

At 420, process 400 may include in response to processor 312 determining that the resource is outside the corresponding active BWP of the resource, reporting, by processor 312 to the network, that apparatus 310 needs an interruption to the corresponding active BWP of the resource.

In some implementations, the resource may be an SSB. In some implementations, the interruption may be used by the processor to perform the at least one L1 measurement using the resource outside the corresponding active BWP. In such implementations, the interruption may include a predetermined time period during which the apparatus does not perform data transmission or data reception before and after SMTC window.

In some implementations, process 400 may further include processor 312 performing an L1 measurement according to an interruption ratio of the interruption to the corresponding active BWP. In some implementations, process 400 may further include processor 312 performing an L1 measurement according to an interruption length of the interruption to the corresponding active BWP.

In some implementations, process 400 may further include processor 312 performing a calculation to determine a value of an interruption ratio based on the interruption length and a measurement cycle length with respect to the corresponding active BWP.

In some implementations, the data transmission and the data reception by apparatus 310 may be interrupted based on the interruption length and a measurement cycle length with respect to the corresponding active BWP.

In some implementations, the interruption may be used by processor 312 to perform an L1 measurement according to an interruption location in the corresponding active BWP.

In some implementations, following the reporting by processor 312 of the need for the interruption, processor 312 may perform during the interruption the at least one L1 measurement for the serving cell based on the resource that is outside the corresponding active BWP. In some implementations, the reporting by processor 312 may include reporting a need for the interruption in order to perform an RF re-turning to enlarge a bandwidth of the corresponding active BWP for conducting the at least one L1 measurement. In such implementations, the at least one L1 measurement may include a L1-RSRP measurement, a L1-SINR measurement, or a L1-RSRQ measurement.

In some implementations, the reporting may include reporting a need for the interruption in order to perform one or more of a RLM measurement, a BFD measurement, or a CBD measurement. In some implementations, the serving cell of the network may be a Pcell, a PScell, or a SCell.

In some implementations, the reporting may include reporting the need for the interruption after transmission of at least one of a RCC reconfiguration message, a DCI message, or a MAC-CE message by the network. In some implementations, the reporting may include reporting the need for the interruption via an existing reporting capability of Layer 3 that is used for reporting L1 measurements.

In some implementations, the processor 312 is configured to perform further operations comprising in response to determining that the resource is within the corresponding active BWP of the resource, reporting, by processor 312 to the network, that apparatus 310 does not need an interruption to the corresponding active BWP of the resource.

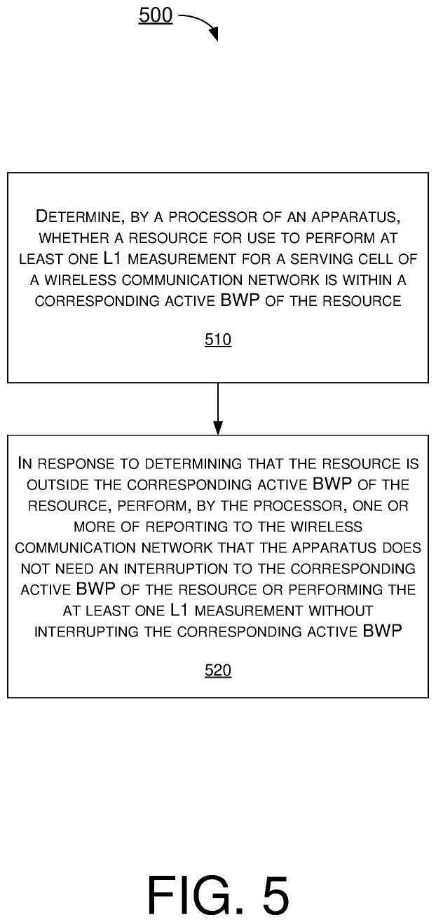

FIG. 5 illustrates an example process 500 in accordance with an implementation of the present disclosure. Process 500 may represent an aspect of implementing various proposed designs, concepts, schemes, systems and methods described above, whether partially or entirely, including those pertaining to those described above. More specifically, process 500 may represent an aspect of the proposed concepts and schemes pertaining to the selective use of BWP interruptions for performing L1 measurements. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 310 and apparatus 320 as well as any variations thereof. Solely for illustrative purposes and without limiting the scope, process 500 is described below in the context of apparatus 310 as a UE (e.g., UE 110) and apparatus 320 as a communication entity such as a network node, a base station, or a core network component (e.g., terrestrial network node 125 or non-terrestrial network node 128) of a network (e.g., network 130 as a 5G/NR mobile network). Process 500 may begin at block 510.

At 510, process 500 may include processor 312 of apparatus 310 determining whether a resource for use to perform at least one L1 measurement for a serving cell of a wireless communication network is within a corresponding active BWP of the resource. Process 500 may proceed from 510 to 520.

At 520, process 500 may include in response to processor 312 determining that the resource is outside the corresponding active BWP of the resource, performing, by processor 312, one or more of reporting to the network that apparatus 310 does not need an interruption to the corresponding active BWP of the resource or performing the at least one L1 measurement without interrupting the corresponding active BWP.

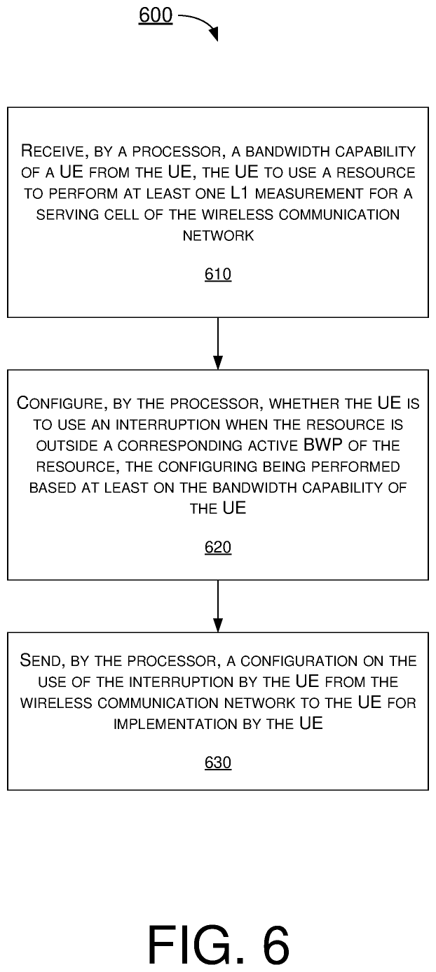

FIG. 6 illustrates an example process 600 in accordance with an implementation of the present disclosure. Process 600 may represent an aspect of implementing various proposed designs, concepts, schemes, systems and methods described above, whether partially or entirely, including those pertaining to those described above. More specifically, process 600 may represent an aspect of the proposed concepts and schemes pertaining to the selective use of BWP interruptions for performing L1 measurements. Process 600 may include one or more operations, actions, or functions as illustrated by one or more of blocks 610-630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 310 and apparatus 320 as well as any variations thereof. Solely for illustrative purposes and without limiting the scope, process 600 is described below in the context of apparatus 310 as a UE (e.g., UE 110) and apparatus 320 as a communication entity such as a network node, a base station, or a core network component (e.g., terrestrial network node 125 or non-terrestrial network node 128) of a network (e.g., network 130 as a 5G/NR mobile network). Process 600 may begin at block 610.

At 610, process 600 may include processor 322 of apparatus 320 receiving a bandwidth capability of a UE from the UE, the UE to use a resource to perform at least one L1 measurement for a serving cell of the wireless communication network. Process 600 may proceed from 610 to 620.

At 620, process 600 may include processor 322 configuring whether the UE is to use an interruption when the resource is outside a corresponding active BWP of the resource, the configuring being performed based at least on the bandwidth capability of the UE. Process 600 may proceed from 620 to 630.

At 630, process 600 may include processor 322 sending a configuration on the use of the interruption by the UE from the network to the UE for implementation by the UE.

In some implementations, the configuring may include configuring whether the UE is to use the interruption based on the bandwidth capability of the UE and a network bandwidth capability of the wireless communication network. In other implementations, the configuration may include one or more of an interruption ratio or an interruption length of the interruption that are used for performing the at least one L1 measurement for the serving cell of the wireless communication network.

In some implementations, process 600 may further include processor 322 receiving a report of a need for an interruption from the UE when the resource is outside the corresponding active BWP of the resource.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus, comprising:
a transceiver configured to communicate wirelessly; and
a processor coupled to the transceiver and configured to perform operations comprising:
determining, by the processor, whether a resource for use to perform at least one Layer 1 (L1) measurement for a serving cell of a wireless communication network is within a corresponding active bandwidth part (BWP) of the resource; and
in response to determining that the resource is outside the corresponding active BWP of the resource, reporting, by the processor to the wireless communication network, that the apparatus needs an interruption to the corresponding active BWP of the resource.

2. The apparatus of claim 1, wherein the resource is a synchronization signal block (SSB).

3. The apparatus of claim 1, wherein the interruption is used by the processor to perform the at least one L1 measurement using the resource outside the corresponding active BWP, and wherein the interruption includes a predetermined time period during which the apparatus does not perform data transmission or data reception before and after an SSB-based measurement timing configuration (SMTC) window.

4. The apparatus of claim 1, wherein the processor is configured to perform further operations comprising performing an L1 measurement according to an interruption ratio of the interruption to the corresponding active BWP.

5. The apparatus of claim 1, wherein the processor is configured to perform further operations comprising performing an L1 measurement according to an interruption length of the interruption to the corresponding active BWP.

6. The apparatus of claim 5, wherein the processor is configured to perform further operations comprising performing a calculation to determine a value of an interruption ratio based on the interruption length and a measurement cycle length with respect to the corresponding active BWP.

7. The apparatus of claim 5, wherein a data transmission and a data reception by the apparatus are interrupted based on the interruption length and a measurement cycle length with respect to the corresponding active BWP.

8. The apparatus of claim 1, wherein the interruption is used by the processor to perform an L1 measurement according to an interruption location in the corresponding active BWP.

9. The apparatus of claim 1, wherein, following the reporting by the processor of a need for the interruption, performing, by the processor of during the interruption, the at least one L1 measurement for the serving cell based on the resource that is outside the corresponding active BWP.

10. The apparatus of claim 1, wherein the reporting includes reporting an need for the interruption in order to perform an RF re-turning to enlarge a bandwidth of the corresponding active BWP for conducting the at least one L1 measurement, the at least one L1 measurement including a L1-reference signal received power (L1-RSRP) measurement, a L1-signal to interference plus noise ratio (L1-SINR) measurement, or a L1-reference signal received quality (L1-RSRQ) measurement.

11. The apparatus of claim 1, wherein the reporting includes reporting a need for the interruption in order to perform one or more of a radio link monitoring (RLM) measurement, a beam failure detection (BFD) measurement, or a candidate beam detection (CBD) measurement.

12. The apparatus of claim 1, wherein the serving cell of the wireless communication network is a primary cell (Pcell), a primary and secondary cell (PSCell), or a secondary cell (SCell).

13. The apparatus of claim 1, wherein the reporting includes reporting a need for the interruption after transmission of at least one of a radio resource control (RCC) reconfiguration message, a downlink control information (DCI) message, or a media access control-control element (MAC-CE) message by the wireless communication network.

14. The apparatus of claim 1, wherein the reporting includes reporting a need for the interruption via an existing reporting capability of Layer 3 that is used for reporting L1 measurements.

15. The apparatus of claim 1, wherein the processor is configured to perform further operations comprising in response to determining that the resource is within the corresponding active BWP of the resource, reporting, by the processor to a wireless communication network, that the apparatus does not need an interruption to the corresponding active BWP of the resource.

16. An apparatus, comprising:
a transceiver configured to communicate wirelessly; and
a processor coupled to the transceiver and configured to perform operations comprising:
determining, by the processor, whether a resource for use to perform at least one Layer 1 (L1) measurement for a serving cell of a wireless communication network is within a corresponding active bandwidth part (BWP) of the resource; and
in response to determining that the resource is outside the corresponding active BWP of the resource, performing, by the processor, one or more of reporting to the wireless communication network that the apparatus does not need an interruption to the corresponding active BWP of the resource or performing the at least one L1 measurement without interrupting the corresponding active BWP.

17. A method, comprising:
receiving, at a wireless communication network, a bandwidth capability of a user equipment (UE) from the UE, the UE to use a resource to perform at least one Layer 1 (L1) measurement for a serving cell of the wireless communication network;
configuring, at the wireless communication network, whether the UE is to use an interruption when the resource is outside a corresponding active bandwidth part (BWP) of the resource, the configuring being performed based at least on the bandwidth capability of the UE; and
sending a configuration on the use of the interruption by the UE from the wireless communication network to the UE for implementation by the UE.

18. The method of claim 17, wherein the configuring includes configuring whether the UE is to use the interruption based on the bandwidth capability of the UE and a network bandwidth capability of the wireless communication network.

19. The method of claim 17, wherein the configuration includes one or more of an interruption ratio or an interruption length of the interruption that are used for performing the at least one L1 measurement for the serving cell of the wireless communication network.

20. The method of claim 17, further comprising receiving, at the wireless communication network, a report of a need for an interruption from the UE when the resource is outside the corresponding active BWP of the resource.
